(19) United States
(12) Patent Application Publication
(10) Pub. No.: US 2006/0106546 A1
(43) Pub. Date: May 18, 2006

(54) System and method for evaluating materials using ultra wideband signals

(75) Inventors: Mark Roberts, Huntsville, AL (US); Larry W. Fullerton, Owens Crossroads, AL (US); James Richards, Fayetteville, TN (US)

Correspondence Address: JAMES RICHARDS, 58 BONING RD, FAYETTEVILLE, TN, 37334, US

(73) Assignee: Time Domain Corporation, Huntsville, AL (US)

(21) Appl. No.: 10/992,595

(22) Filed: Nov. 17, 2004

(51) Int. Cl. G06F 19/00

(52) U.S. Cl. 702/27

(57) ABSTRACT

A system for evaluating properties of materials by probing the materials using ultra wideband signals wherein the probing may be by transmission or by reflection of radiated ultra wideband signals. Received signals may be evaluated by determining signal characteristics including reflection coefficient, transmission attenuation, multipath decay profile, and signal scattering coefficient. Received signals are evaluated using deconvolution and Fourier processing. Test chamber characteristics and boundary reflections may be removed to yield bulk material properties. The system may be calibrated by employing empirical signal measurements from materials with known properties measured by reference techniques.

### FIELD OF THE INVENTION

The present invention pertains generally to the field of materials characterization and evaluation, and more particularly to the evaluation of materials by probing with electromagnetic signals.

### BACKGROUND OF THE INVENTION

Throughout industry and commerce materials of various types need to be evaluated. From the raw materials, to the finished product, to the deployment in the field, materials need to be evaluated. Raw materials, such as corn, wheat, cotton, sand, cement, and wood are variable in weight, in part due to variable moisture content. Since these materials may be sold based on weight, the moisture content is a factor in the price, a factor, which may be ignored due to a lack of available instrumentation. Further, moisture content may be critical to the product quality. The moisture content of sand is a factor in cement mixing, a factor usually ignored or factored in by guesswork. The moisture content of cotton or wheat may be suggestive of mold or decay. The moisture content of soil may be valuable in the management of an irrigation system. Moisture content is thus one material property in need of measurement.

Other material properties need monitoring as well. Water quality and the environment are in need of monitoring. Manufactured products as diverse as cereal, meat, soft drinks, milk, fabrics, meshes, mats, plastics, tires and more are in need of monitoring for process control and quality assurance. Properties such as moisture content, oil or fat content, density, thickness, uniformity and freedom from voids are only some of the material properties in need of monitoring.

Therefore there is a need for a system and method for evaluating materials that is non-destructive, non invasive, can be used at a distance, fast responding, low cost.

### BRIEF DESCRIPTION OF THE INVENTION

Briefly, the present invention comprises a system for evaluating properties of materials by probing the materials using ultra wideband signals wherein the probing may be by transmission or by reflection of radiated ultra wideband signals. Received signals may be evaluated by determining signal characteristics including reflection coefficient, transmission attenuation, multipath decay profile, signal scattering coefficient, and polarization. Received signals are evaluated using deconvolution and Fourier processing. Test chamber characteristics and boundary reflections may be removed to yield bulk material properties. The system may be calibrated by employing empirical signal measurements from materials with known properties measured by reference techniques.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates a block diagram of a system for evaluating materials using ultra wideband signals in accordance with the present invention.

FIG. 2 illustrates an alternative block diagram of a system for evaluating materials using ultra wideband signals in accordance with the present invention.

FIG. 3 illustrates an exemplary UWB transmitted signal.

FIG. 4A-FIG. 4C illustrate exemplary received pulses showing various levels of multipath reflections.

FIG. 5 illustrates an exemplary received pulse in high multipath showing the first arriving pulse and the multipath response.

FIG. 6 depicts a typical spectral response function.

FIG. 7 and FIG. 8 illustrate alternative systems including a timing source for synchronizing the transmitter and receiver.

### DETAILED DESCRIPTION OF THE PREFERRED EMBODIMENTS

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in art.

Introduction

The present invention is a system and method for evaluating material properties by probing with an ultra wideband signal. In one embodiment, the signal is transmitted through the material from one side to another to measure transmission and/or scattering properties. In another embodiment, the signal is transmitted into the material and the receiver is positioned to receive reflected and/or scattered energy. The receiver may be synchronized to the transmitter, or alternatively, the receiver may be asynchronous and determine relative timing by tracking the signal.

The received signal is then characterized and signal properties are measured. The signal may be evaluated by deconvolution, pattern matching, or Fourier techniques. The signal properties may include, but are not limited to transmission attenuation, reflection coefficient, multipath decay profile, signal scattering coefficient, and polarization. Material properties that may be evaluated include, but are not limited to moisture content, density, thickness, uniformity and freedom from voids.

In one embodiment, container or wall effects are removed to better identify bulk properties. The signal properties are then compared with a database of signals from materials of known properties. Alternatively, the database may be reduced to lookup tables or functional relationships to speed the process. When a proper match is found, the material properties are thus determined.

Of particular interest is moisture content. Because water absorbs microwave energy, the absorption of microwave energy by a material will often be substantially due to the moisture content. Thus, the moisture content of a material may often be determined by observing the absorption of microwave energy.

UWB offers unique capability to observe microwave absorption and scattering characteristics because of the precise timing resolution available. Using UWB, the direct path response can be separated from the scattering response, and edge effects can be separated from the bulk effects. Thus, the properties of the materials may be more thoroughly characterized than can be done using narrow band techniques.

UWB offers further advantages over physical contact detectors because UWB can operate at a distance—enabling operation such as non-contact, non-invasive inspection, inspection of packaged goods, and aerial environmental surveys.

The UWB sensor has no inherent wear out mechanism, enabling use in long life, high reliability applications, and contributing to low life cycle costs.

The UWB technique is non destructive and fast responding, enabling use with finished articles, and items on a fast conveyor belt.

UWB Basics

The present invention builds upon existing impulse radio techniques. Accordingly, an overview of impulse radio basics is provided prior to a discussion of the specific embodiments of the present invention. This section is directed to technology basics and provides the reader with an introduction to impulse radio concepts, as well as other relevant aspects of communications theory. This section includes subsections relating to waveforms, pulse trains, coding for energy smoothing and channelization, modulation, reception and demodulation, interference resistance, processing gain, capacity, multipath and propagation, distance measurement, and qualitative and quantitative characteristics of these concepts. It should be understood that this section is provided to assist the reader with understanding the present invention, and should not be used to limit the scope of the present invention.

Ultra Wideband is an emerging RF technology with significant benefits in communications, radar, positioning and sensing applications. In 2002, the Federal Communications Commission (FCC) recognized these potential benefits to the consumer and issued the first rulemaking enabling the commercial sale and use of products based on Ultra Wideband technology in the United States of America. The FCC adopted a definition of Ultra Wideband to be a signal that occupies a fractional bandwidth of at least 0.25, or 400 MHz bandwidth at any center frequency. The 0.25 fractional bandwidth is more precisely defined as:

$$FBW = \frac{2 ( {f}_{h} - {f}_{l} )}{{f}_{h} + {f}_{l}} ,$$

where FBW is the fractional bandwidth, fh is the upper band edge and fl is the lower band edge, the band edges being defined as the 10 dB down point in spectral density.

There are many approaches to UWB including impulse radio, direct sequence CDMA, ultra wideband noise radio, direct modulation of ultra high-speed data, and other methods. The present invention has its origin in ultra wideband impulse radio and will have significant application there as well, but it has potential benefit and application beyond impulse radio to other forms of ultra wideband and beyond ultra wideband to conventional radio systems as well. Nonetheless, it is useful to describe the invention in relation to impulse radio to understand the basics and then expand the description to the extensions of the technology.

The following is an overview of impulse radio as an aid in understanding the benefits of the present invention.

Impulse radio has been described in a series of patents, including U.S. Pat. No. 4,641,317 (issued Feb. 3, 1987), U.S. Pat. No. 4,813,057 (issued Mar. 14, 1989), U.S. Pat. No. 4,979,186 (issued Dec. 18, 1990), and U.S. Pat. No. 5,363,108 (issued Nov. 8, 1994) to Larry W. Fullerton. A second generation of impulse radio patents includes U.S. Pat. No. 5,677,927 (issued Oct. 14, 1997), U.S. Pat. No. 5,687,169 (issued Nov. 11, 1997), U.S. Pat. No. 5,764,696 (issued Jun. 9, 1998), U.S. Pat. No. 5,832,035 (issued Nov. 3, 1998), and U.S. Pat. No. 5,969,663 (issued Oct. 19, 1999) to Fullerton et al., and U.S. Pat. No. 5,812,081 (issued Sep. 22, 1998), and U.S. Pat. No. 5,952,956 (issued Sep. 14, 1999) to Fullerton, which are incorporated herein by reference.

Uses of impulse radio systems are described in U.S. Pat. No. 6,177,903 (issued Jan. 23, 2001) titled, “System and Method for Intrusion Detection using a Time Domain Radar Array” and U.S. Pat. No. 6,218,979 (issued Apr. 17, 2001) titled “Wide Area Time Domain Radar Array”, which are incorporated herein by reference.

Acquisition approaches are described in U.S. Pat. No. 5,832,035, titled “Fast Locking Mechanism for Channelized Ultrawide-Band Communications,” issued Nov. 3, 1998 to Fullerton, which was incorporated by reference above, and in U.S. Pat. No. 6,556,621, titled “System and Method for Fast Acquisition of Ultra Wideband Signals,” issued Apr. 29, 2003 to Richards et al., which is incorporated herein by reference.

System and Method for Evaluating Materials Using Ultra Wideband Signals.

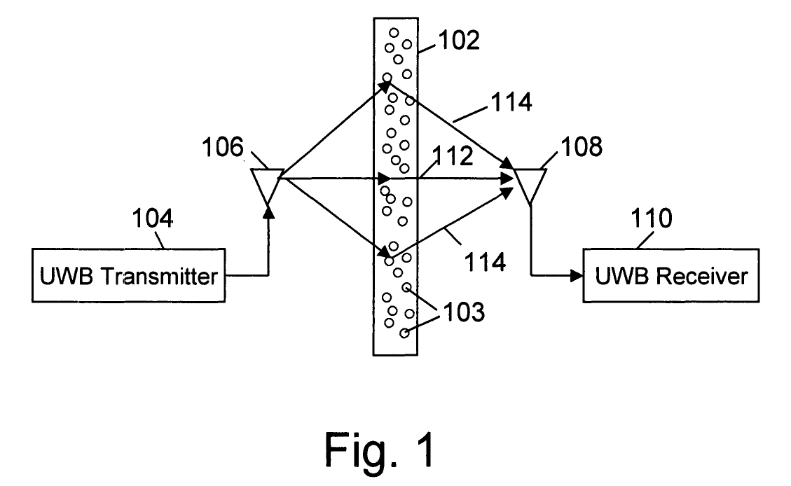

FIG. 1 illustrates a block diagram of a system for evaluating materials 102 using ultra wideband signals in accordance with the present invention. The system of FIG. 1 is configured to evaluate transmission and scattering properties of the material 102, which may include reflective internal features, or scatterers, 103. Referring to FIG. 1, a UWB transmitter 104 transmits a UWB signal using a transmitting antenna 106. A directional antenna may be beneficially employed to direct the UWB signal toward the material 102. The UWB signal is modified by the material 102 according to the material 102 properties. The modified signal is then received by receiving antenna 108 and coupled to a receiver 110 where the modified signal corresponds to direct transmission signal 112 and scatterer reflections 114. The receiver 110 includes a processor for analyzing the received signal to determine received signal characteristics that are then compared with known received signal characteristics for the material 102 properties to determine the transmission and scattering properties of material 102.

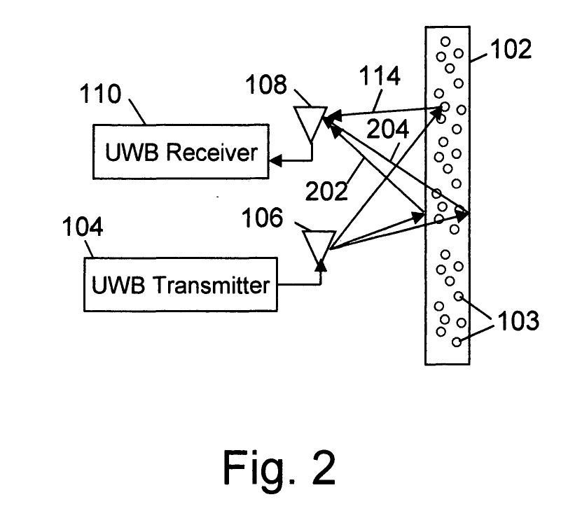

FIG. 2 illustrates an alternative block diagram of a system for evaluating materials 102 using ultra wideband signals in accordance with the present invention. The system of FIG. 2 is configured to evaluate reflection and scattering properties of the material 102. Referring to FIG. 2, a transmitter 104 transmits a signal via a transmitting antenna 106 toward the material 102. The material 102 modifies the transmitted signal in accordance with the material 102 properties. Specifically, the modified signal corresponds to surface reflections 202, 204 reflecting off the front and back surfaces of the material 102, and scatterer reflections 114 reflecting off scatterers 103 contained within material 102. The modified signal is received by a receiver 110 using a receiving antenna 108. The receiver 110 of FIG. 2 also includes a processor for analyzing the received signal to determine received signal characteristics. The received signal characteristics are then compared with received signal characteristics from material samples with known properties to determine the properties of the test material 102. The configuration of FIG. 2 may be used as an alternative to the configuration of FIG. 1 or in combination with the configuration of FIG. 1. In combination, the transmission, reflection, and scattering properties of material 102 may be evaluated.

Alternatively, the material 102 of FIG. 1 or FIG. 2 may be housed in a test chamber or the signal may be directed through a duct or waveguide.

UWB includes at least two unique signal characteristics that can be used to advantage in material 102 evaluation, wide bandwidth and precise timing. The wide bandwidth allows instantaneous sampling of the response over a broad range of frequencies, further, the operating band may be selected to take advantage of unique material 102 characteristics. The precise timing allows direct transmission signal 112 and scatterer reflections 114 to be separated. The separation of direct transmission signal 112 and scatterer reflections 114 enables better bulk attenuation measurements, allows analysis of the scattering properties of the material 102 and enhances rejection of interfering scatterer reflections 114 in the test environment.

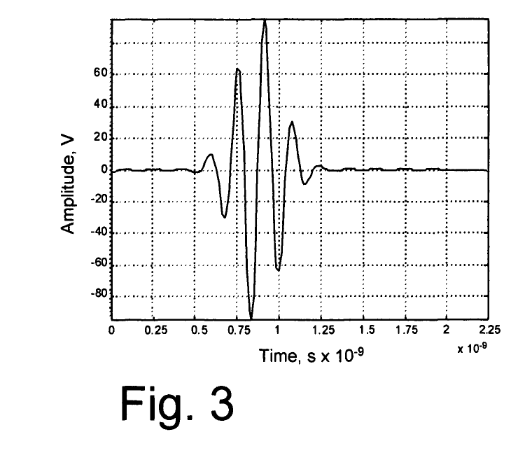

FIG. 3 illustrates an exemplary UWB transmitted signal. The signal of FIG. 3 represents a pulse with a center frequency of 5 GHz. The data in FIG. 3 is measured data from a pulse.

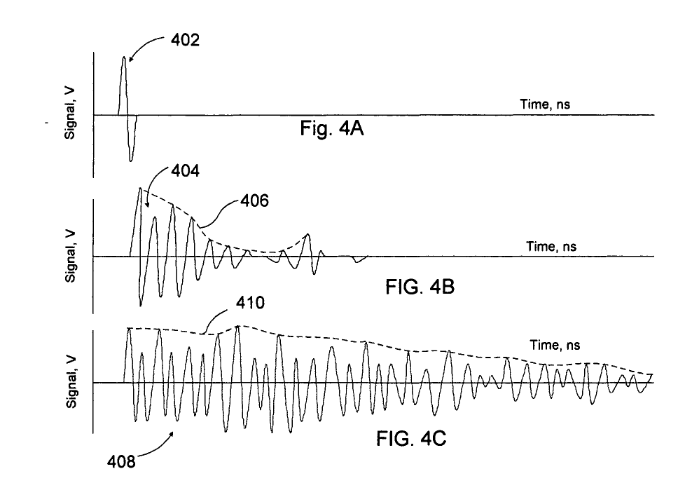

FIG. 4A-FIG. 4C illustrate exemplary received pulses showing various levels of multipath reflections. The illustrations of FIGS. 4A-4C are drawn to illustrate the principle of the present invention. FIG. 4A depicts a transmitted pulse 402 showing one main RF cycle. The pulse 402 of FIG. 4A would also be a received pulse in the absence of any multipath reflections. FIG. 4B illustrates a received pulse 404 in the presence of a moderate number of multipath reflections. The magnitude of multipath reflection signal generally decreases with time offset from the leading edge because the later reflections generally travel longer paths. The amplitude of the multipath signal often appears noise like because the reflections may add or subtract according to their individual phases, often suggesting a Rayleigh like amplitude distribution. FIG. 4C illustrates a received pulse 408 with high multipath showing a longer tail with a slower envelope amplitude decay.

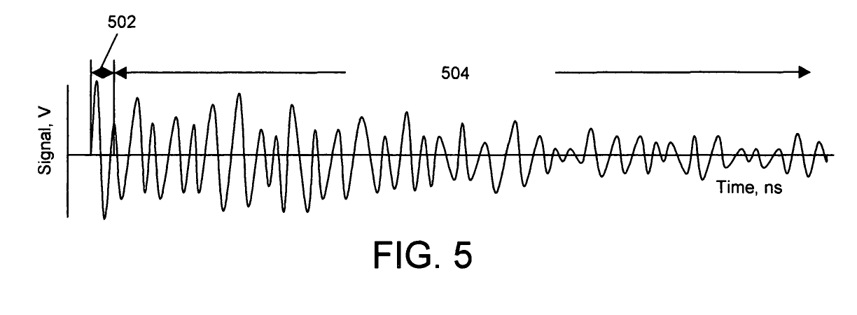

FIG. 5 illustrates an exemplary received pulse in high multipath showing the first arriving pulse 502 and the multipath response 504. Referring to FIG. 5, and FIG. 1, the first lobe of FIG. 5 represents the pulse arriving from the direct transmission signal 112 in FIG. 1. The remaining lobes are the sum of pulses from scattered reflections 114 in FIG. 1.

In a similar manner, FIG. 5 may illustrate the signal received from the system of FIG. 2. Referring to FIG. 5 and FIG. 2, the first arriving pulse 502 is the pulse from path 202 from the front surface of the material 102. The remaining multipath response 504 is the sum of scatterer reflections 114 from internal features of the material 102. Included in the remaining response 504 is a reflection from the back surface 204 (not shown in FIG. 5.)

Processing of Received Signals

Received signals may be processed to determine a number of signal characteristics. The signal characteristics include, but are not limited to attenuation, multipath decay slope, signal delay, and frequency response.

In an exemplary system such as the system of FIG. 1 or FIG. 2, a signal scan may be produced for evaluation of one or more signal properties. A signal scan is typically produced by transmitting a plurality of pulses and receiving at multiple time offset delays from the transmitted pulses. For example. 100 pulses may be sent and received with a 10 nanosecond (ns) delay. The 100 received samples are summed for a first data point. This is followed by another 100 pulses received by a 10.1 ns delay and another 100 pulses by a 10.2 ns delay and so on until 100 data points are accumulated with 0.1 ns delay differential. The resulting sequence is a scan of the signal.

Scans may be produced by a radar as shown in FIG. 2. Scans may also be produced by a transmitter and receiver as shown in FIG. 1. The transmitter and receiver may be synchronized by a common timing source or the receiver may be synchronized by acquiring and locking on part of the signal. Signal acquisition and tracking techniques are further explained in U.S. patent application Ser. No. 10/955,118, titled System and Method for Fast Acquisition of Ultra Wideband Signals, filed Sep. 30, 2004, which is incorporated herein by reference.

Techniques for producing scans are further explained in U.S. Pat. No. 6,614,384 and U.S. patent application Ser. No. 09/537,264, which are incorporated herein by reference.

In one embodiment, signal attenuation is used to evaluate the material property. For example, moisture content may increase the attenuation of a signal transmitted through a material. Alternatively moisture content may be observed by an increased reflection from a material, or possibly by an increased absorption by the material as may be observed by a decreased reflection from the back surface of a material (or from a reflector placed behind the material), or from a change in the scattering (multipath) produced by the material.

Referring to FIG. 5, signal attenuation may be determined by observing the attenuation in the first arriving pulse 502. This may be accomplished by a first observation of the strength of the first arriving pulse 502 without the material 102 in the path, then inserting the material 102 and then making a second observation of the strength of the first arriving pulse 502. The ratio of the first and second observations is the attenuation and may be related to a material 102 property such as moisture content, or thickness or density, other attenuation related property. In this way, multipath reflections 504 are rejected entirely from the calculation. Scatterer reflections 114 from the material 102, or from the test chamber or environment may likewise be rejected. In a system with a fixed geometry needing only to test direct transmission signal 112 attenuation, a single time delay at the time of the first arriving pulse 502 may be sufficient and a full scan of the signal may be unnecessary.

Alternatively, material properties, especially uniformity, freedom from voids, cracks and other defects may be determined by observing the multipath signal component 504. Products having a coarse form may produce a characteristic multipath envelope. Normally uniform products with a void defect or crack may also produce a multipath reflection associated with the void or crack.

In some materials, the transmission and reflectivity may be an indication of purity related to conductivity. For example, UWB penetrates fresh water much more readily than salt water. Thus, the absorption, or reflectivity may be an indication of the saltiness, or purity of water.

Signal Characteristics

A number of signal characteristics may be evaluated and used to determine material properties. These characteristics include signal envelope and spectrum. Referring to FIG. 4B and FIG. 4C, a multpath response waveform including a first arriving pulse and a multipath response. An envelope 406, 410 of the waveform may be determined. As shown, the amplitude of each successive peak may be used. The resulting envelope 406, 410 may then be curve fit to an appropriate profile such as exponential, straight line or quadratic function to determine a decay coefficient. The decay coefficient may then be compared with decay coefficients related to known materials to determine the material property.

Alternatively the envelope 406, 410 may be determined by finding the Hilbert transform of the scan data and then finding the square root of the sum of the squares of the scan data and the Hilbert transform.

Alternatively, the scan waveform may be deconvolved before determining the decay profile.

Deconvolution may be especially valuable for viewing the internal structure of a material for finding voids or cracks or for rejecting surface or packaging effects. Deconvolution can sharpen the edges and minimize the effect of the RF cycles in determining feature locations. Deconvolution can be noise enhancing, however, so a good signal to noise ratio is desirable for good deconvolution. Deconvolution may also help determine the thickness of a material. By identifying front and back surface reflections in the system of FIG. 2. Deconvolution may be accomplished by using Fourier processing as is known in the art. Alternatively, deconvolution may be accomplished using an algorithm known as the Clean algorithm wherein a pulse pattern is matched to the scan data and the peak match is subtracted from the data. The remainder data is then matched again and the peak match subtracted from the data and so on until the remainder is sufficiently small. Each match becomes a response in the deconvolution. Thus, precise time and amplitude responses are determined. The Clean algorithm may work well in determining material thickness by identifying precise points for the front and back surface reflections. Use of the Clean algorithm is described in greater detail in a paper by R. Jean-Marc Cramer, Robert A. Scholtz, and MoeZ Win, titled “Evaluation of an Ultra-Wide-Band Propagation Channel”, which published in IEEE Transcation on Antennas and Propagation, Vol 50, No. 5, in May 2002, incorporated herein by reference.

Spectral analysis may also help determine material properties. Because the UWB pulse has a very wide bandwidth, a wide range of frequencies are sampled with each pulse. The spectrum may be evaluated by directly observing the signal modified by the material by using a spectrum analyzer. Alternatively, the pulse response waveform may be scanned and the scan data processed by a Fourier processor, such as an FFT algorithm. Since a typical pulse has a characteristic spectrum, the spectral response typically compares the spectrum modified by the material with the source spectrum to determine the difference (in dB) or ratio (in linear units).

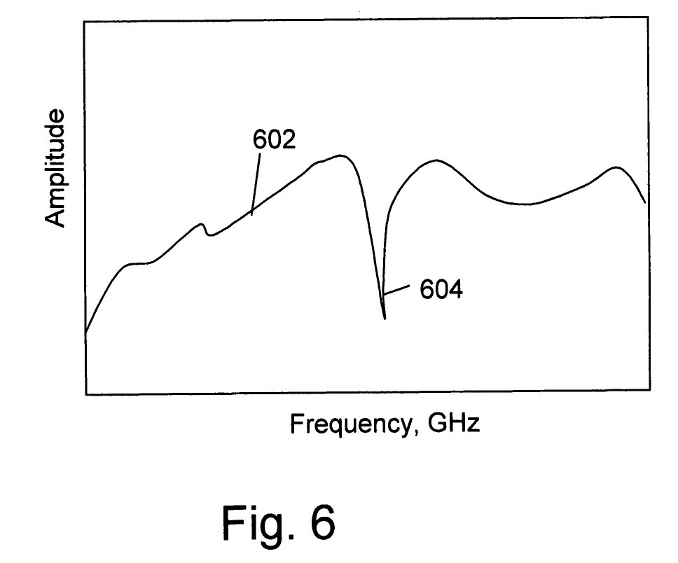

FIG. 6 depicts a typical spectral response function 602. Referring to FIG. 6, the spectral response function 602 is observed to have a notch 604 in the center of the band. A notch 604 may be produced by an absorption band relating to a material 102 property. A notch 604 may also indicate wave interference such as from a reflection from the front and back surface of the material 102, relating to the thickness of the material 102. Note also that the spectral response function 602 slopes across the band. Depending on the band and the material 102 property, the feature of interest may be a general slope in the frequency response across the band.

By using a selected portion of the scan response, environmental features can be eliminated. For example, if only the first nanosecond (ns) of response (beginning with the direct transmission signal 112 response) is processed by the FFT, then reflections from the test setup and nearby articles having delays greater than one nanosecond will be eliminated from the result. Narrow band systems cannot easily achieve this capability.

Material Properties

The relationship between signal characteristics and material properties is typically defined by obtaining a range of materials having a range of properties that are measured by a reference process. The reference materials are placed in a test setup to be used later for measurement of unknown specimens. The reference materials are scanned and analyzed and the results recorded. A relationship may be developed by curve fitting or other appropriate techniques to develop a formula, or empirically derived equation, for determining the material property based on the signal characteristic. Alternatively, a table lookup with interpolation may be used.

As part of the calibration process, test fixture characteristics may be determined so that they may be removed during testing. The test chamber may be scanned while empty or a reflecting aluminum sheet may be placed in the test article location at the front surface or at the back surface. Or a reference test article may be placed in the test chamber to determine reference front and back reflections.

Alternate Architectures

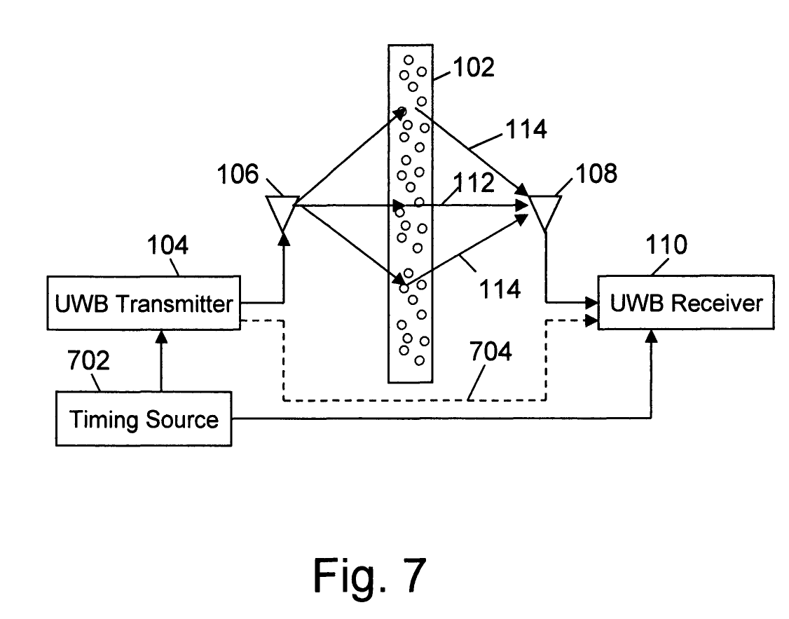

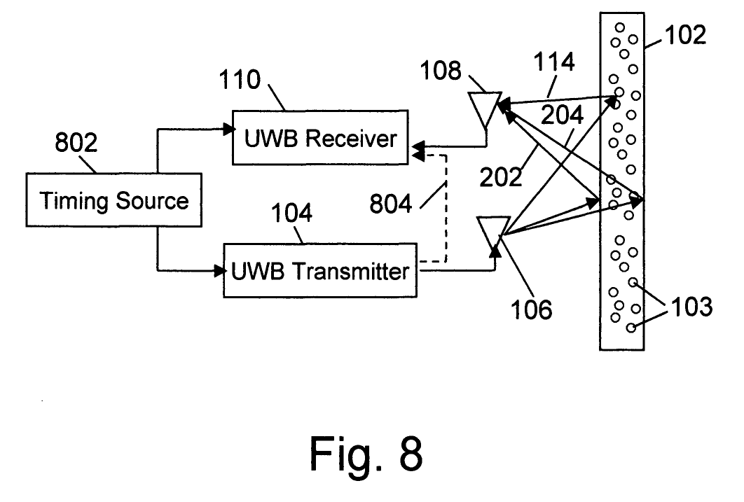

FIG. 7 and FIG. 8 illustrate alternative systems including a timing source for synchronizing the transmitter 104 and receiver 110. Referring to FIG. 7, a timing source 702 is added to the system of FIG. 1. The timing source 702 is coupled to the transmitter 104 and the receiver 110 so that the receiver 110 may be synchronized to the transmitter 104. By synchronizing the receiver 110 in this way, the distance between the transmitter 104 and receiver 110 may be measured by the delay between the transmit pulse and the received pulse. Reflections and artifacts may be removed because of the stable timing. Alternatively, the timing reference may be derived by coupling a portion of the transmitted pulse through a cable 704 to the receiver 110.

Referring to FIG. 8, a timing source 802 is added to the system of FIG. 2. By synchronizing the transmitter 104 and receiver 110, the distance to the material 102 may be determined by the delay between the transmit pulse and the receive pulse. Alternatively, the timing reference may be derived by coupling a portion of the transmitted pulse through a cable 804 to the receiver 110. As a further alternative, reference timing may be derived from the direct transmission signal 112 coupling between the transmitter 104 antenna and receiver 110 antenna. In some systems, the transmitter 104 and receiver 110 may share the same antenna.

In an alternative embodiment, the material 102 may be mounted to rotate between the transmitter 104 and receiver 110. A scan may be captured for each rotation angle and the scan data may then be processed to generate a multi-dimensional result as in tomography.

Polarization

With some materials, polarization may be used to evaluate the material. Normally, the same polarization is used for the transmitter and receiver antennas, however, for materials that may alter the polarization, the transmitter and receiver antennas may be placed at orthogonal polarizations. Certain crystals may rotate optical polarization. Diagonal conductors may couple energy from one polarization to another.

Circular polarization (CP) may be used as well. For example, right handed CP may be directed to the material and right handed or left handed CP may be received from the material and the response may then be related to the material property.

Materials

A wide range of materials and properties may be probed by UWB signals. Some materials include but are not limited to: Water, environment, foliage, soil, foods, potato chips, corn flakes, cereal, corn, wheat, cotton, tissue (human, animal, plant), sand, cement, asphalt, wood, plastic, mesh, fabric, mats, composites, and more.

Some of the properties include, but are not limited to: moisture content, density, thickness, conductivity, purity, salt content, cracks, voids, uniformity, and more.

### CONCLUSION

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof. Thus, the breadth and scope of the present invention should not be limited by any of the above-described exemplary embodiments, but should be defined only in accordance with the following claims and their equivalents.

All cited patent documents and publications in the above description are incorporated herein by reference.

We claim:

1. A method for evaluating a property of a material comprising
directing a first UWB signal toward the material;
receiving a second UWB signal from the material;
determining a received signal characteristic;
relating the received signal characteristic to the material property;
determining the material property.

2. The method of claim 1 wherein said second signal includes a direct transmission signal component.

3. The method of claim 1 wherein said second signal includes a reflected signal component.

4. The method of claim 1 further including a timing source to provide timing for directing a first UWB signal and for receiving a second UWB signal, wherein said receiving a second UWB signal is synchronized to said timing source.

5. The method of claim 1 wherein said determining step includes producing a scan of a plurality of said received signals at a plurality of time offsets.

6. The method of claim 5 wherein the determining step includes deconvolution of a said scan using a received pulse pattern to determine a path impulse transfer function.

7. The method of claim 6 wherein the deconvolution is performed using a CLEAN algorithm.

8. The method of claim 5 wherein the determining step includes a Fourier transform of said scan.

9. The method of claim 5 wherein the determining step includes determining a multipath profile.

10. The method of claim 9 wherein the multipath profile is used to determine an attenuation coefficient.

11. The method of claim 9 wherein the multipath profile is used to determine a scattering coefficient.

12. The method of claim 11 wherein the determination of the scattering coefficient includes subtracting a direct path component.

13. The method of claim 1 wherein the material property is determined by table lookup.

14. The method of claim 1 wherein the material property is determined by an empirically derived equation.

15. The method of claim 1 wherein the material property is one of the group moisture content, density, thickness, conductivity, purity, and salt content.

16. A system for evaluating a property of a material comprising:
a UWB transmitter for generating a probing signal;
a first coupling device for coupling said probing signal to said material;
a UWB receiver for receiving a response signal from said material;
a second coupling device for coupling said response signal from said material to said receiver;
a signal processor for determining a received signal characteristic and relating said received signal characteristic to said property of said material to determine said property of said material.

17. The system of claim 16 wherein the first coupling device is an antenna.

18. The system of claim 16 wherein the first coupling device is a waveguide.

19. The system of claim 16 further including a timing generator coupled to said transmitter and said receiver, wherein said transmitter and said receiver are synchronized.

20. The system of claim 16 wherein the receiver acquires and tracks said response signal.
